(19) United States
(12) Patent Application Publication
(10) Pub. No.: US 2008/0059309 A1
(43) Pub. Date: Mar. 6, 2008

(54) TARGETED PRODUCT SAMPLE DELIVERY METHOD

(76) Inventor: Timothy S. Welch, Paradise Valley, AZ (US)

Correspondence Address: YOUNG & BASILE, P.C., 3001 WEST BIG BEAVER ROAD, SUITE 624, TROY, MI, 48084, US

(21) Appl. No.: 11/849,427

(22) Filed: Sep. 4, 2007

Related U.S. Application Data
(60) Provisional application No. 60/841,810, filed on Sep. 1, 2006.

(51) Int. Cl. G06Q 30/00

(52) U.S. Cl. 705/14

(57) ABSTRACT

A product sample delivery method to targeted consumers to expose a consumer to a product sample exposure media and allow the consumer to request a sample of a product by using address and message information found on the sample exposure media to send a wireless message via a portable communication device in order to send the product sample to the consumer.

### CROSS REFERENCE TO CO-PENDING APPLICATION

This application claims the benefit of the priority filing date of U.S. Provisional Patent Application Ser. No. 60/841,810 filed Sep. 1, 2006, the contents of which are incorporated herein in its entirety.

### BACKGROUND

In retail marketing, the delivery of a product sample to a consumer is a valuable tool in increasing product sales. The product samples can be delivered on a mass market basis to all consumers residing within a particular locale. Product samples can also be more directly targeted by sending product samples only to those consumers who appear on customer lists associated with the products having characteristics which are similar to the sample products.

Improvements in targeting the delivery of product samples are still desirable.

Thus, it would be desirable to provide a product sample delivery method which is capable of connecting with targeted consumers, has the capability for communication with the engaged consumers about brands and obtain consumer feedback, converts consumers to brand buyers at higher conversion rates, builds a relationship with that consumer, and tracks sales via coupons, conversion studies and on-line sales data.

### SUMMARY

Methods of performing a product sample delivery method to targeted consumers are disclosed herein. One such method comprises exposing a consumer to a product sample exposure media; providing address and message information on the sample exposure media to enable the consumer to send a wireless message via a portable communication device identifying a request to receive the product sample; and sending the product sample to the consumer.

### BRIEF DESCRIPTION OF THE DRAWING

The various features, advantages and other uses of the present invention will become more apparent by referring to the following detailed description and drawing in which:

FIG. 1 is pictorial representation of a product sample delivery method to selected consumers;

FIGS. 2-6 are pictorial representations showing individual steps in the method depicted generally in FIG. 1;

FIG. 7 is a flow diagram of a portion of the method; and

FIG. 8 is a chart depicting various manufacturer/retailer sample program level participation options.

### DETAILED DESCRIPTION

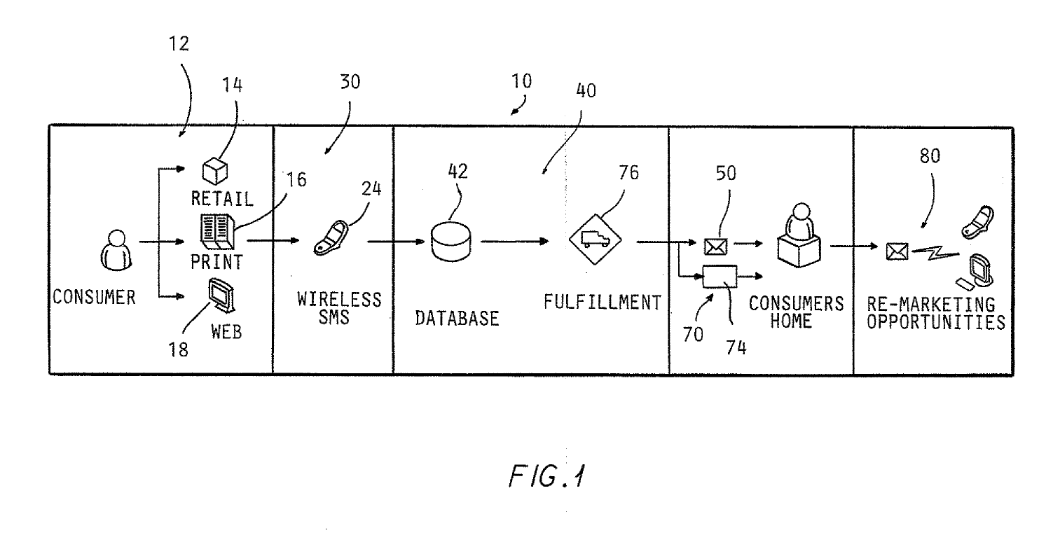

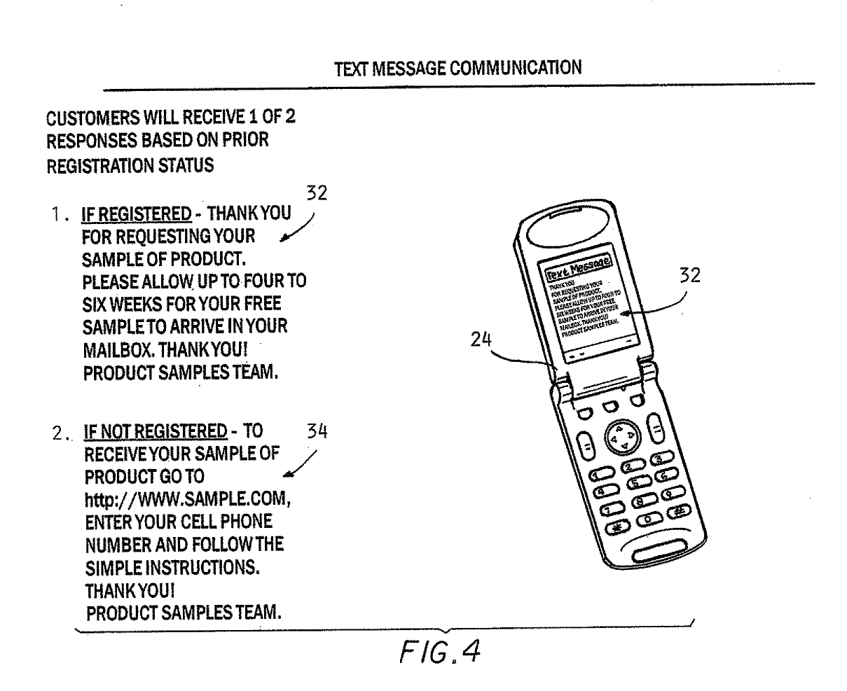

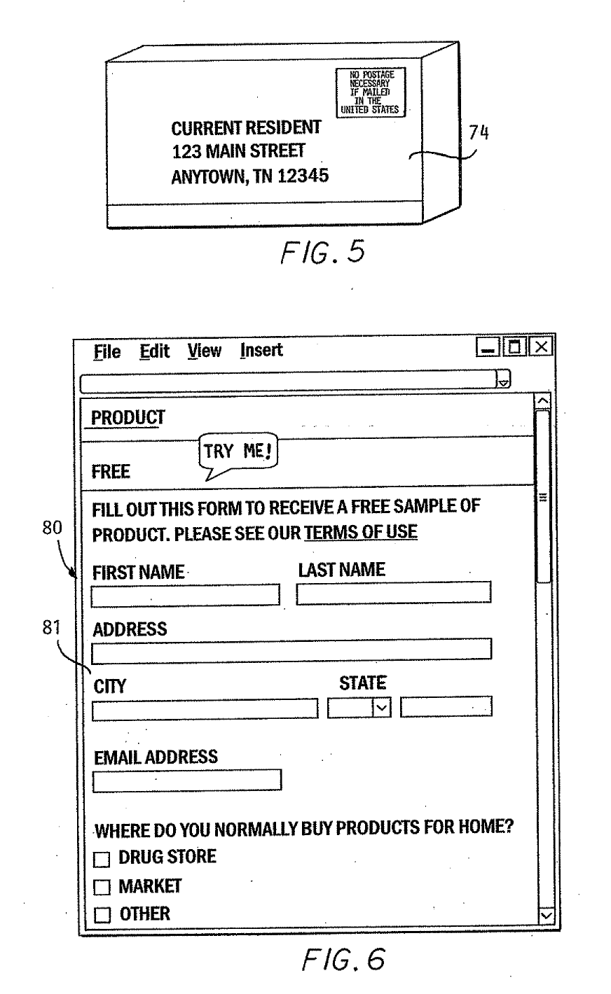

Referring to FIGS. 1-8 of the drawings, there is depicted a product sample delivery method 10 which is capable of delivering product samples to selected, targeted consumers.

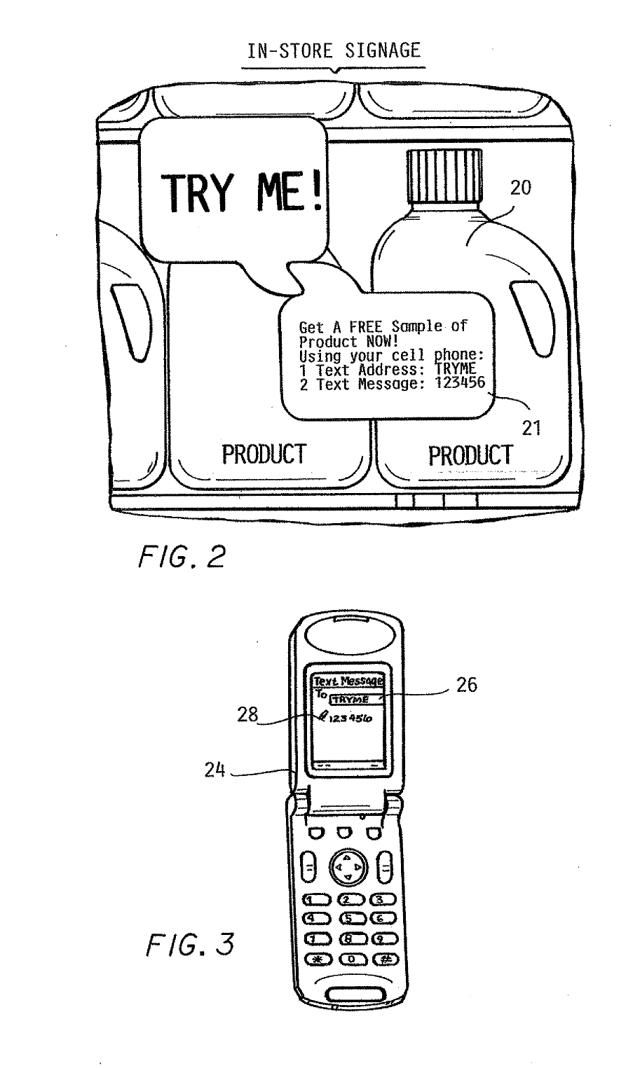

As shown in FIGS. 1 and 2, the initial step in the present method is exposure of consumer to products which are part of the sample delivery program. Such exposure can be in retail stores 14, by print media 16, ads on television or radio, or through the Internet or web 18.

As shown in FIG. 2 at the retail level, a retailer will provide visual indication of a product in the store which is part of the product sample delivery program. Various indicia may be provided, typically in the form of display and/or audio device such as a shelf talker, a dangler, a divider rail strip, a floor graphic or any other visual and/or audible indicator which can be located in close proximity to the product.

Print media 16 can include any print media, such as magazines, newspaper, transportation signs, direct mail, etc.

The Internet or web exposure can be on third party websites, on-line marketing or on-line marketing including banner ads, PPC, RSS reads, etc.

The exposure time of each promotion can be dictated by the retailer for a preset time, such as one week, two weeks, etc. At the end of the preset promotion time period, the exposure media, including retail signs 14, print media 16 and/or Internet or web advertisements 18 are removed.

The display shown in FIG. 2 is an example of any of the mediums 14, 16, 18 will identify the product 20 and present an offer 21 to obtain a free sample of the product.

Regardless of the media 14, 16 or 18 used, the media offers a consumer the ability to obtain a free sample of the product 20 through an activation step such as by utilizing their cell phones, see FIG. 3, to send an SMS message 26 to a text address, identified by the letters (TRYME), for example, followed by a unique alpha numeric message 28; such as an 8-digit number, identify any or all of a particular product, store location, promotion program, etc.

As an alternative to the use of the text message or SMS communication by cell phone, the activation step could include an indication for the consumer to go to “retailerwebsite.com” using any web-enabled device to register for a free sample of the product 20.

Immediately upon sending the wireless SMS message in step 30, the consumer will receive on his or her cell phone 24 one of two responses 32, 34 based on whether or not the particular consumer has previously registered with the sample program. If the consumer is registered the message 32 could read “Thank You for requesting a sample of the Product. Please allow up to two weeks for your, free sample to arrive in your mail box. Thank You! Retailer Samples Team.”

If the consumer is not registered with the sample program, a message 34 can be sent to the user's cell phone such as “To Receive Your Sample Of the Product go to http://www.sampletize.com, enter your cell phone number and follow the simple instructions. Thank You! Retailer Sample Team.”

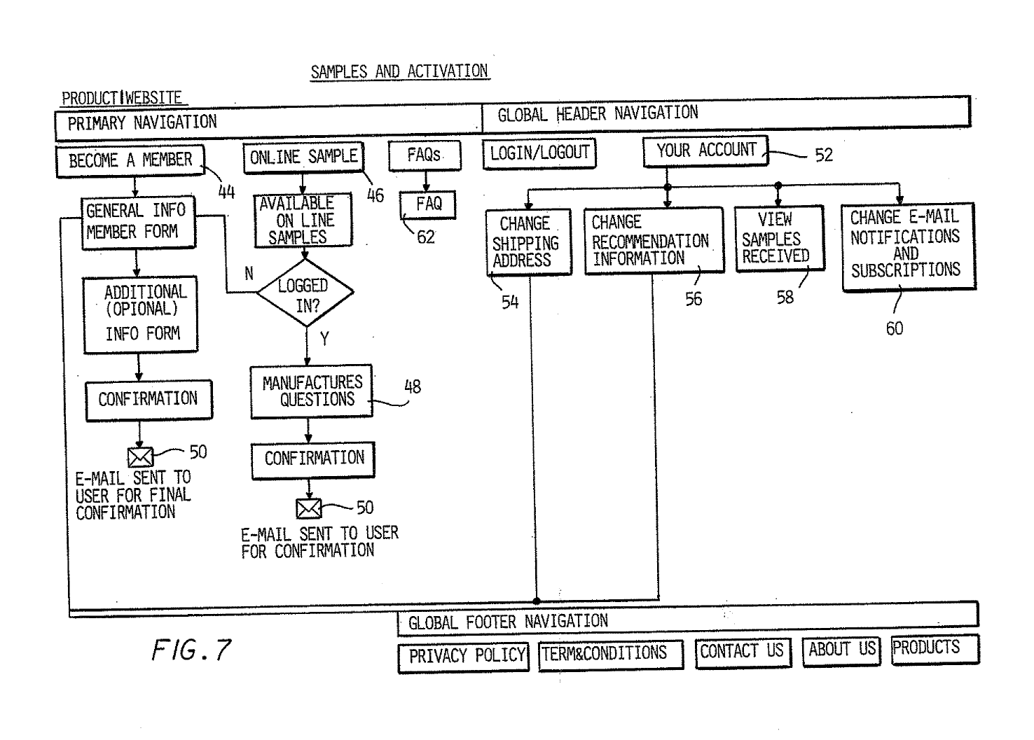

As shown in FIGS. 1 and 7, the text message from the consumer and/or the accessing of the Sample Product website of step 40 causes the consumer phone number and product ID information to be stored in a sample database 42.

As shown in detail in FIG. 7 when a consumer, who sends a text message requesting a sample of product 20 has not previously registered and is directed to the sample website as described above in step 30, is presented with a series of information request screens containing questions and data insertion areas for becoming a member of the sample program as shown by the general sequence starting with method step 44. The consumer may also view an online sample sequence starting with method step 46, which can include questions from the product manufacturer in step 48. The end result of either series of inquires 44, 46 is the delivery of an email message in step 50 confirming that the sample has been shipped.

The sample website also includes additional consumer screens, shown in FIG. 7, which enable the consumer to monitor his or her account in step 52. The consumer can, for example, change a shipping address in step 54, change recommendation information about a particular product in step 56, view a sample that a particular consumer has received in step 58, as well as change email notification and subscriptions in step 60. A general FAQs screen is also available in step 62.

The database 42 is capable of storing various data, such as the cell phone number of each consumer who sends a text or SMS message 26 requesting the delivery of a product sample along with the consumer registration information. A delivery or fulfillment sequence is initiated in step 70, as shown in FIG. 1, which causes a product sample 74 to be processed from the manufacturer, a distributor or other source and shipped to the requesting consumer in a set time period, such as one or two weeks. The email acknowledgement 50 will also be sent to the consumer as a confirmation that the product sample has been shipped.

When the product sample 74 has been shipped, an optional trackable coupon may also be included with the product sample 74. The trackable coupon will carry identification indicating a specific consumer and additional information, such as the promotion program, initial store location, etc. This information can be coded in any suitable coding means, such as a barcode on the coupon. The trackable coupon enables subsequent purchases by the consumer of a product 20 identical to the product sample 74 to be monitored.

In optional step 80, shown in FIGS. 1 and 6, post sample research can be gathered via email, direct mail or telephone to an eligible consumer who requested a product sample. Such post sample research or feedback can be gathered at any time, such as approximately two to four weeks after the delivery of the sample product to the consumer, which is dependent upon the type of product sample.

Such feedback survey 81 can ask the consumer about their experience with the product sample and/or trackable coupon so as to provide a quick insight in future purchase intent, category/brand awareness, sample usage and rating, product attribute rating, etc.

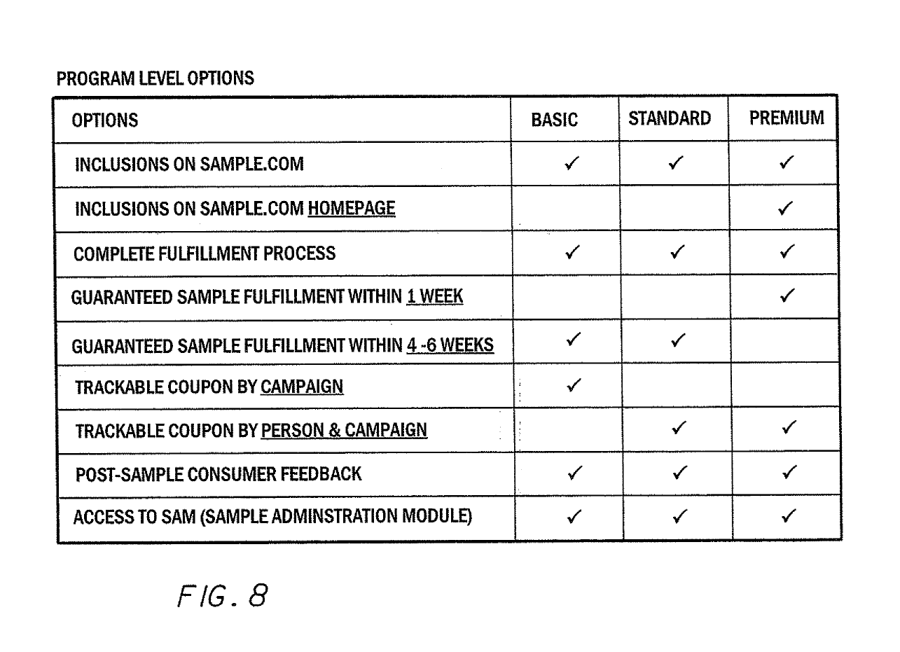

For a product manufacturer/retailer various sample program level options are available as shown in FIG. 8. These options are covered in three levels, labeled “basic, standard, and premium”, The check marks indicate what options are available in each program level. The first two options include a listing of the manufacturers and/or retailers name on the sample program or anywhere on the website and/or on the website home page. The program level options also guarantee sample fulfillment including sample delivery and/or any optional feedback surveys within a different preset time, including a shorter period, such as one week, or a longer period, such as four to six weeks.

The program levels also provide options between the use of the optional trackable coupon to indicate the product campaign as well as the product campaign end the consumer name.

The program level options also provide optional post sample consumer feedback and access to a sample administration module to provide data enabling the manufacturer and retailer to manage, track, and determine the success of the advertising campaign.

What is claimed is:

1. A product sample delivery method to targeted consumers comprising of steps:
exposing a consumer to a product sample exposure media;
providing address and message information on the sample exposure media to enable the consumer to send a wireless message via a portable communication device identifying a request to receive the product sample; and
sending the product sample to the consumer.

2. The method of claim 1 further comprising of step:
receiving a response message identifying the consumer as one of registered or unregistered.

3. The method of claim 1 wherein the step of providing the message information further comprises of step:
providing in the message information at least one of a unique product code, a store location and a promotion program.

4. The method of claim 3 further comprising of step:
storing the unique product code and at least one of a portable communication device identifier and consumer identification information in a database.

5. The method of claim 1 further comprising of step:
registering a consumer to receive the product sample by obtaining consumer identification information.

6. The method of claim 1 wherein the step of exposing the consumer to the sample exposure media further comprises of step:
exposing the consumer to the sample exposure media through at least one of a retail store, a print medium, a television broadcast, a radio broadcast, an interconnected system of networks, or a set of electronic documents interlinked through the interconnected system of networks.

7. The method of claim 1 further comprising of step:
enabling the consumer to view online product samples; and
enabling the consumer to order the online product samples.

8. The method of claim 1 further comprising of step:
providing questions from at least one of a product manufacturer and a product retailer pertaining to the product sample.

9. The method of claim 1 further comprising of step:
delivering an electronic confirmation message to the consumer.

10. The method of claim 1 further comprising of step:
enabling the consumer to modify account information.

11. The method of claim 1 further comprising of step:
providing common questions and answers pertaining to the product sample delivery method.

12. The method of claim 1 further comprising of step:
sending a trackable coupon identifying at least one of a product advertising campaign and consumer identification information when the product sample is sent to the consumer.

13. The method of claim 1 further comprising of step:
sending a feedback survey to the consumer within a predetermined time period after delivery of the product sample to the consumer.

14. The method of claim 1 further comprising of step:
enabling at least one of a product manufacturer and a product retailer to manage, track, and determine the success of a product advertising campaign through a sample administration module.
